(19) United States
(12) Patent Application Publication
(10) Pub. No.: US 2003/0226684 A1
(43) Pub. Date: Dec. 11, 2003

(54) Robust wiring device cover plate

(76) Inventors: Gerd Schmieta, Boston, MA (US); Michael Meyer, Boston, MA (US); Dennis Oddsen, Eatons Neck, NY (US); Anthony Tufano, North Massapequa, NY (US); Leslie Lindenstraus, New York, NY (US); James J. Sherman, Jericho, NY (US); Tim Langfitt, Nappa, CA (US)

Correspondence Address: GREENBERG TRAURIG, LLP, 885 Third Avenue, New York, NY, 10022, US

(21) Appl. No.: 10/236,617

(22) Filed: Sep. 6, 2002

Related U.S. Application Data
(63) Continuation-in-part of application No. 10/163,487, filed on Jun. 6, 2002.

(51) Int. Cl. H02G 3/14

(52) U.S. Cl. 174/66

(57) ABSTRACT

There is disclosed structure which overcomes the deficiencies with respect to prior art devices by providing a wiring device such as a receptacle or a spring loaded switch having a paddle that pivots about its upper end and is biased to assume the same at rest position when either in its on position or off position. Repeated pressing and releasing the lower portion of the face of the switch paddle alternately closes and opens a set of contacts within the switch to alternately connect and disconnect a load from a source of electricity each time the paddle is pressed. Thus, regardless of whether adjacent switches are on-off switches or 3-way switches, they will always be in alignment. An on-off indicator such as a small light, a flag in a window, a mechanical protrusion of the like can be provided to indicate to a user when the contacts of the switch are opened or closed. The paddle of the switch has a length-width ratio dimension that is proportioned to provide a finger contact surface of increased area to allow a user to more easily and quickly identify and operate a particular switch. The cover plate has a single opening containing no separating members for receiving one or more wiring devices. The contour of the cover plate around the switch along a section which runs along its vertical axis defines a new functional surface shape of positive first differential and zero second differential, comprised of a combination of splines drawn between points of varying distance from a datum plane. The contour has zero second differential when the rate of height increase of individual splines is constant. The contour of the face of the switch paddle follows the contours and shape of the cover plate. When the wiring device is a receptacle, the contour along the width of the face is flat in one plane and the contour along the length of the face has a constant radius. The shape of the front of the receptacle allows for the proper seating of an inserted plug.

This application is a continuation in part of application Ser. No. 10/163,487, filed Jun. 6, 2002.

### BACKGROUND OF THE INVENTION

1. Field of the Invention

The present invention relates generally to the field of wiring devices installed in boxes mounted in building walls and more particularly to a cover plate that covers wiring devices.

2. Description of the Related Art

At the present time when it is desired to modify the wiring in an existing building, whether public, commercial or residential by adding or changing a wiring device such as a switch, a receptacle, a duplex receptacle, or a combination receptacle and switch, etc., it is necessary to cut a hole in a wall of the building, install a box within the hole, attach the box to a stud and install the wiring device into the box. In new construction, the box is attached to a stud of an open wall and, thereafter, the wall, which may be sheet rock having an opening for access to the box, is placed over the studs. The box is hollow to receive such wiring devices and provides pairs of mounting ears for mounting the wiring devices within and to the box. The box selected is sized to accept all the wiring devices required at that location and the number of pairs of mounting ears is equal to the number of possible wiring devices which the box can receive. Once a wiring device is connected to the various conductors it will service, it is screwed to at least one pair of ears to mount the wiring device in and to the box. The process of connecting a wiring device to various conductors and then attaching the wiring device with the attached wires to the box is done for each wiring device located within the box. Thereafter, a cover plate is positioned over the wiring devices in the box. In many instances, the box will contain multiple wiring devices positioned side by side. Typical installations can include single or multiple wiring devices positioned side by side in a common box. In installations where there are multiple wiring devices in a common box, the installation of the cover plate can be time consuming. More specifically, the wiring devices must be aligned with each other, must be positioned parallel to each other and must be spaced from each other by a distance dictated by the spacing between the openings in the cover plate. In addition, the multiple wiring devices should be flat against the wall. A common contributor to the misalignment of multiple wiring devices relative to each other in a common box is that the conductors attached to the various wiring devices exert different forces in different directions on the various wiring devices which bias them in different directions. Misalignment and positioning problems are also caused by boxes that are skewed relative to the wall or the wall is not flat. A cover plate having suitable openings, normally a separate opening in the cover plate for each wiring device, is installed over the exposed wiring devices and the ganged box after all of the wiring devices are finally positioned relative to each other.

A common type of wiring device in use today is the rocker type of electrical switch that pivots about a centrally located horizontal axis. To operate, the rocker switch is pushed in at the top to supply electricity to a load such as a light and is pushed in at the bottom to disconnect the load from the source of electricity. Thus, when there are two or more rocker type of switches positioned side by side in a box, the switches can be in opposite positions at any one time. For example, the top edge of one switch will be flush with the top surface of the cover plate when in its on position; and the top edge of an adjacent switch will protrude from the top surface of the cover plate when in its off position. The in-out positioning of adjacent switches can also occur when both switches are in their on or off state if one or each of the switches is a 3-way switch. This irregular positioning of adjacent rocker switches presents an aesthetically discordant appearance. In addition, the irregular in-out positioning of adjacent switches can create operational uncertainty as to which switch is on or off when subsequent activation or deactivation of less than all of the rocker switches is required by a user.

A switch and cover plate which is more functional is desired. In those instances where multiple switches are positioned side by side in a common box, it is particularly desirable that the switches always be in alignment with each other regardless of whether they are in their on or off state. It is also desired to overcome the difficulties of accurately locating wiring devices in a common box, positioning the wiring devices within the box and aligning the wiring devices with respect to each other to the facilitate the placing of a cover plate over the wiring devices.

### SUMMARY OF THE INVENTION

There is disclosed structure which overcomes the deficiencies with respect to prior art devices by providing a spring loaded switch having a paddle that pivots about its upper end and is biased to assume the same at rest position when either in its on position or off position. Repeated pressing and releasing the lower portion of the face of the switch paddle alternately closes and opens a set of contacts within the switch to alternately connect and disconnect a load from a source of electricity each time the paddle is pressed. Thus, regardless of whether adjacent switches are on-off switches or 3-way switches, they will always be in alignment. An on-off indicator such as a small light, a flag in a window, a mechanical protrusion of the like can be provided to indicate to a user when the contacts of the switch are opened or closed. The paddle of the switch has a length-width ratio dimension that is proportioned to provide a finger contact surface of increased area to allow a user to more easily and quickly identify and operate a particular switch. The cover plate located around the switch has a single opening with no separating members for receiving adjacently positioned switches. The contour of the cover plate around the switch along a section which runs along its vertical axis defines a new functional surface shape of positive first differential and zero second differential, comprised of a combination of splines drawn between points of varying distance from a datum plane. The contour has zero second differential when the rate of height increase of individual splines is constant. The paddle of the switch is not located within a stationary frame and follows the contours and shape of the cover plate. In those instances where the wiring device is a receptacle, the contour along the width of the face is flat in one plane and the contour along the length of the face has a constant radius. The shape of the front of the receptacle allows for the proper seating of an inserted plug.

The foregoing has outlined, rather broadly, the preferred feature of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention and that such other structures do not depart from the spirit and scope of the invention in its broadest form.

### BRIEF DESCRIPTION OF THE DRAWINGS

Other aspects, features, and advantages of the present invention will become more fully apparent from the following detailed description, the appended claim, and the accompanying drawings in which similar elements are given similar reference numerals.

FIG. 1 is a front perspective view of the cover plate installed over a wall mounted rocker switch of a prior art device;

FIG. 2 is an exploded view of the switch, attachment plate and cover plate of the prior art device of FIG. 1;

FIG. 3 is a front perspective view of the cover plate installed over a wall mounted switch in accordance with the instant invention;

FIG. 4 is an exploded view of the switch, alignment plate and cover plate of structure in accordance with the principles of the invention;

FIG. 5 is a front perspective view of the alignment plate for attaching a single wiring device to a box;

FIG. 6 is a front perspective view of a wiring device such as the switch of FIG. 3 with an exploded view of the captive member attached to the end of the ground strap of the switch;

FIG. 7 is a front perspective view of the cover plate of the inventive device;

FIG. 8 is a view along the line B-B from edge L to edge K of FIG. 7;

FIG. 9 is a side elevation sectional view of the cover plate taken along the line 4-4 of FIG. 7;

FIG. 10 is a side elevation, partially in section of the cover plate as shown in FIG. 7 installed on a ground strap and alignment plate;

FIG. 11 is a fragmentary enlarged side elevation of the latching pawl of the captive member engaging the saw-tooth rack of the cover plate;

FIG. 12 is a fragmentary, enlarged side elevation in section of the cover plate and tab of the alignment plate to indicate how the two components can be separated following latching;

FIG. 13 is an exploded view of a ganged box, a cover plate and alignment plate according to the invention for two wiring devices;

FIG. 14 is an exploded view of a ganged box, a cover plate and alignment plate according to the invention for three wiring devices; and,

FIG. 15 is an exploded view of a ganged box, a cover plate and alignment plate according to the invention for four wiring devices.

### DESCRIPTION OF THE PREFERRED EMBODIMENT

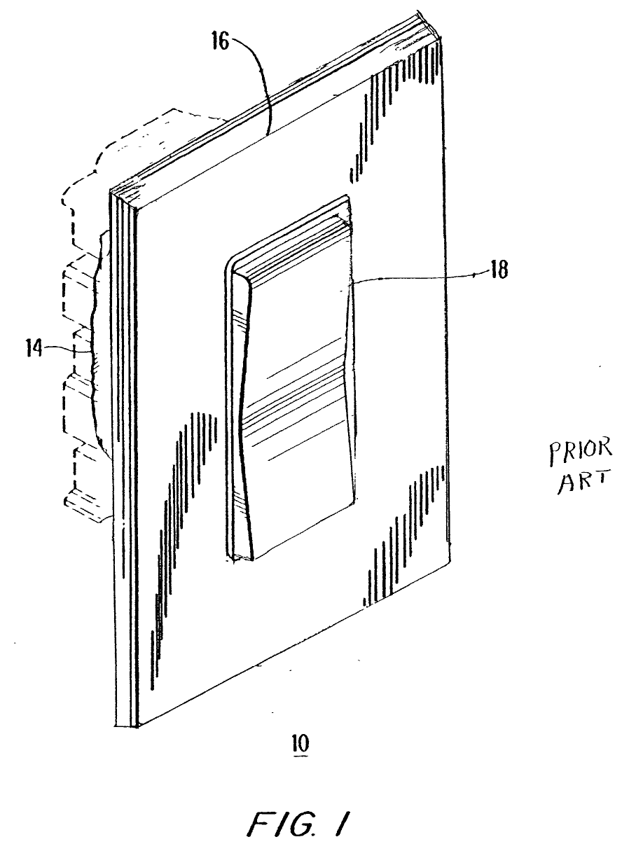

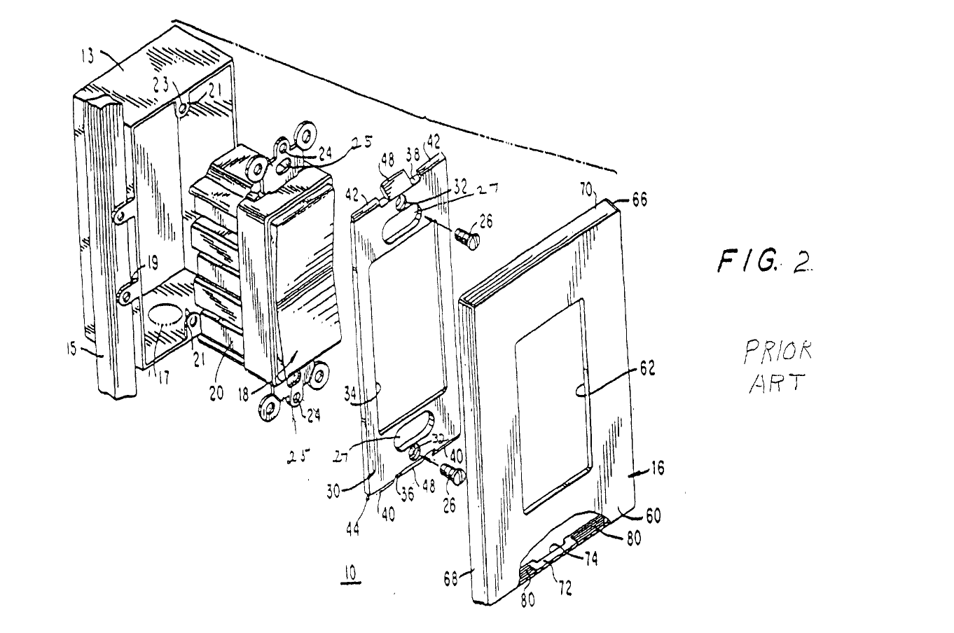

Referring to FIG. 1, there is illustrated a front perspective view of a wiring device, cover plate assembly 10 of the prior art. Referring to FIG. 2 which is an exploded view of the box, switch, attachment plate and cover plate of the prior art device of FIG. 1, a suitable aperture is cut into a wall to provide access for a box 13 mounted to a stud 15, or to permit installation of a suitable box to an adjacent stud or directly to the material of the wall (such as plasterboard). The box 13 is large enough to accept as many wiring devices as are needed. The box 13 is made of metal or plastic, has one or more openings in its sides or back to permit the introduction of electrical cables into the interior of the box 13 and has mounting means 19 to permit the box to be anchored to the adjacent stud 15. The box supports pairs of mounting ears 21. Each mounting ear contains a threaded aperture 23 to which can be fastened the mounting screws of the wiring device such as, for example, rocker switch 18 or a receptacle. In the normal order of assembly, electrical cables are passed through knock out openings 17 to the interior of the box. The ends of the electrical cables are stripped of insulation and attached to contacts on the side or rear of the body 20 of the switch 18. After the electrical cables are attached to contacts on the side or rear of the body of the switch, the switch is pushed into the box and held in position by screws (not shown) that are passed through clearance openings such as elongate mounting slots 25 and threaded into openings 23 of ears 21 to mount switch 18 to the box 13. Thereafter, attachment plate 30 is positioned around the front of the switch and secured to the switch with mounting screws 26 which pass through clearance openings 32 in the attachment plate and are threaded into openings 24 in the ears of the wiring device. Attachment plate 30 also contains a main aperture 34 of a shape complimentary with the profile of the front of the switch 18 which extends through it. The aperture 34 in FIG. 1 is rectangular to accept the front of the switch 18. The head of the screw which passes through aperture 25 of switch 18 and engages threaded opening 23 of lugs 21 is larger than the aperture 25 and, therefore, holds switch 18 captive to the box 13. In a similar manner, the head of the screw which passes through aperture 32 of the attachment plate 30 and engages threaded opening 24 of the ear of the switch is larger than the aperture 32 and, therefore, holds attachment plate 30 captive to the switch 18.

At each end 36, 38 respectively, of attachment plate 30 are two latching pawls 40, 42. Pawl 40 has a leg 44 which is an extension of attachment plate 30 but is much thinner and terminates in an angled leg 48 which extends at about a 45 degree angle with respect to the horizontal top edge of end 38 of attachment plate 30.

Cover plate 16 is proportioned to fit over attachment plate 30 as well as the box into which the single wiring device, rocker switch 18, is placed and to which it is fastened.

To attach cover plate 16 to attachment plate 30, pawls 40, 42 of attachment plate 30 are made to engage saw-tooth shaped racks 80 on the inner surfaces of end walls 70 and 72 of cover plate 16 as the cover plate is pushed in.

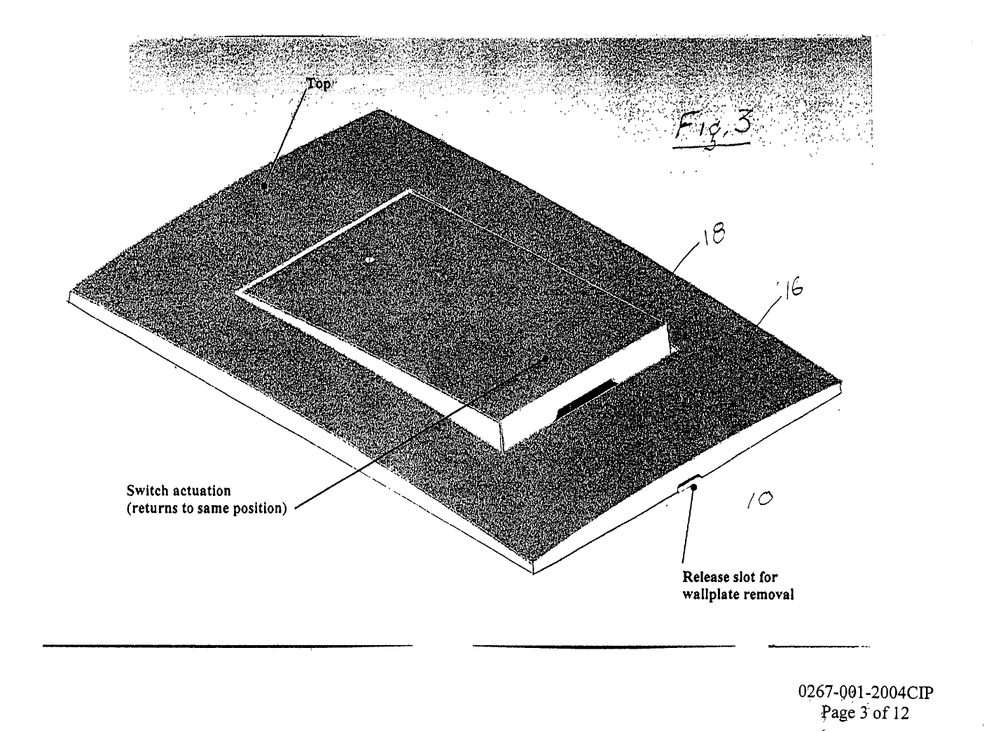

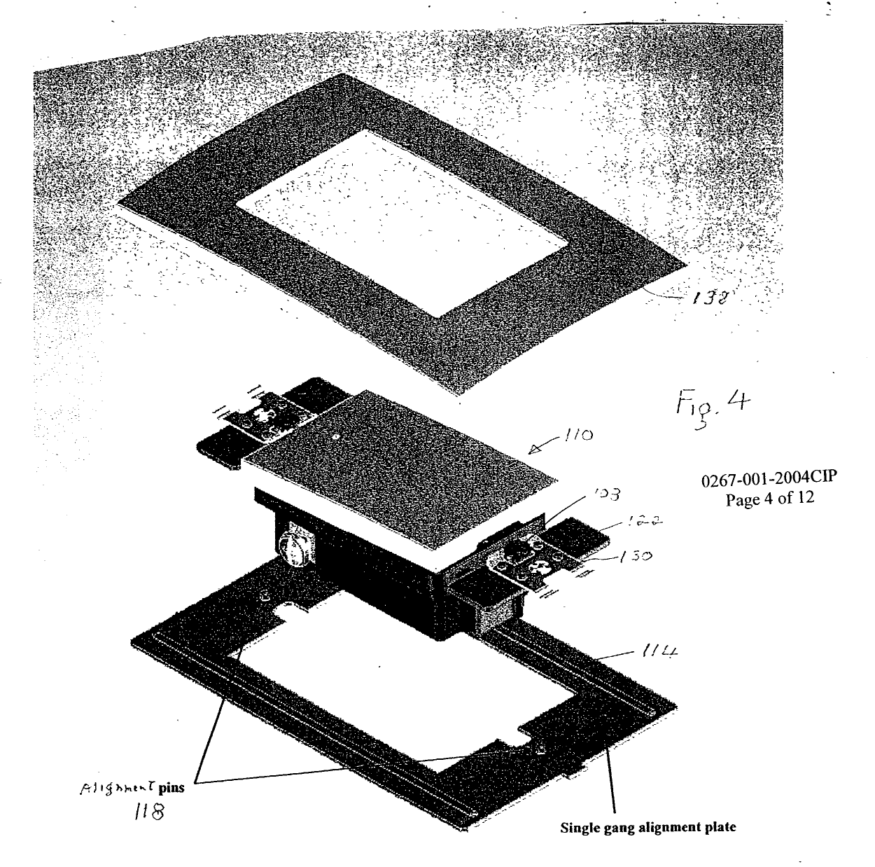

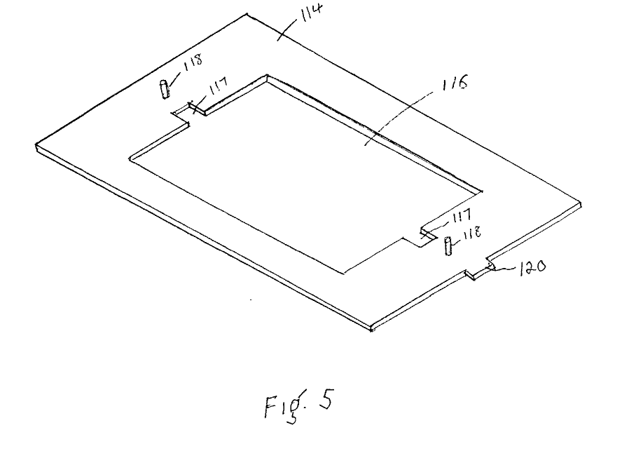

FIG. 3 is a front perspective view of a wiring device and cover plate assemblage of structure in accordance with the principles of the invention; and FIG. 4 is an exploded view illustrating an alignment plate 114 ( more fully disclosed in FIGS. 5, 10, 11, 12, 13, 14 and 15 and the description that relates thereto) having alignment pins 118 positioned to engage captive member 130 ( more fully disclosed in FIG. 6 and the description that relates thereto) located on lugs 122 at the ends of the ground strap of switch 110 ( more fully disclosed in FIG. 6 and the description that relates thereto). As illustrated in FIG. 2, a box 13 large enough to accept as many wiring devices as are needed is mounted in a wall. The box is made of metal or plastic, has one or more openings in its side or back to permit the introduction of cables into the interior of the box and has mounting means 19 to permit the box to be anchored to an adjacent stud 15. Electrical cables are passed through knock out openings 17 to the interior of the box and the ends of the electrical cables are stripped of insulation in preparation for attaching the cables to the switch 110. The box supports pairs of mounting ears 21. Each mounting ear contains a threaded aperture 23 to receive mounting screws 108 of a wiring device such as, for example, switch 110. After the wires in the box are attached to terminals on the switch, the switch is attached to an alignment plate 114 and the switch and alignment plate are couple to the box by means of screws 108. Thereafter, cover plate 138 is placed over the switch, alignment plate and box assembly.

Referring to FIG. 5, there is illustrated a perspective of the alignment plate 114 of FIG. 4. Alignment plate 114, which can be composed of metal such as cold rolled steel or the like, supports a centrally located rectangular opening 116 sized to accept a wiring device such as switch 110 or a receptacle. Centrally located at each end of the rectangular opening and contiguous with the opening 116 are two clearance openings 117 which provide clearance for mounting screws 108 which secure the switch 110 and alignment plate 114 to the box 100. Located beyond the outer edge of each clearance opening 117 are alignment pins 118. The alignment pins are provided to engage openings located in captive members 130 attached to lugs 122 at the ends of the ground strap of the switch. Alignment plate 114 supports a tab 120 that projects outward from the lower end and is used to facilitate removal of a cover plate from around the face of a switch. The outside dimensions of the alignment plate are such that it can extend beyond at least one dimension of the box to which the switch is attached. It is to be noted that the alignment plate illustrated in FIG. 5 is for a single wiring device.

Referring to FIG. 6, there is illustrated a new improved wiring device such as switch 110 in accordance with the principles of the invention. Switch 110 supports a ground strap having a lug 122 at each end which provides support for captive members 130 by means of screws, rivets, spot welds or the like. Each lug 122 can be rectangular in shape and support two openings 126 and 128. Openings 126 can be oval, square or rectangular in shape and is a clearance opening for mounting screws 108 which are normally provided by the manufacturer of the wiring device for attaching the wiring device to the box. The distance between centers of openings 126 in lugs 122 on the ground strap is equal to the distance between the centers of openings 23 in ears 21 of box 13 (see FIG. 2) to allow mounting screws 108 in openings 126 to engage and be held captive by the threaded openings 23. It is here noted that clearance openings 117 in alignment plate 114 (see FIG. 5) are clearance openings for mounting screws 108. Openings 128 in the lugs 122 are clearance openings for alignment pins 118 of alignment plate 114.

Continuing with FIG. 6, a captive member 130 composed of phosphor bronze, spring brass, spring steel or the like is securely attached to the lugs 122 which form the ends of the ground strap of switch 110. Captive member 130 contains a first opening 132 which is aligned with opening 126 in the lug and a second opening 134 which is aligned with opening 128 in the underlying lug. Opening 132 can be oval or rectangular in shape to allow a mounting screw to be positioned off center. A centrally located projection 136 bent at a slight downward angle toward the body of the switch is provided to engage and hold loosely captive the threaded body of the mounting screw. Engagement of projection 136 with the mounting screw provides a good electrical connection between the ground strap of the switch, the screw and the box to insure that the switch is connected to ground. The screw which passes through openings 132 and 126 of the switch and opening 117 of the alignment plate 114, threads into opening 23 in the box to hold the switch and alignment plate to the box. The openings 132 and 126 are sized to allow the screw to be moved laterally to compensate for slight misalignments that may occur. Opening 134 in captive member 130 is substantially circular and supports three inwardly projecting members alignment pins are provided to engage openings located in captive members 130 attached to lugs 122 at the ends of the ground strap of the switch. Alignment plate 114 supports a tab 120 that projects outward from the lower end and is used to facilitate removal of a cover plate from around the face of a switch. The outside dimensions of the alignment plate are such that it can extend beyond at least one dimension of the box to which the switch is attached. It is to be noted that the alignment plate illustrated in FIG. 5 is for a single wiring device.

Referring to FIG. 6, there is illustrated a new improved wiring device such as switch 110 in accordance with the principles of the invention. Switch 110 supports a ground strap having a lug 122 at each end which provides support for captive members 130 by means of screws, rivets, spot welds or the like. Each lug 122 can be rectangular in shape and support two openings 126 and 128. Openings 126 can be oval, square or rectangular in shape and is a clearance opening for mounting screws 108 which are normally provided by the manufacturer of the wiring device for attaching the wiring device to the box. The distance between centers of openings 126 in lugs 122 on the ground strap is equal to the distance between the centers of openings 23 in ears 21 of box 13 (see FIG. 2) to allow mounting screws 108 in openings 126 to engage and be held captive by the threaded openings 23. It is here noted that clearance openings 117 in alignment plate 114 (see FIG. 5) are clearance openings for mounting screws 108. Openings 128 in the lugs 122 are clearance openings for alignment pins 118 of alignment plate 114.

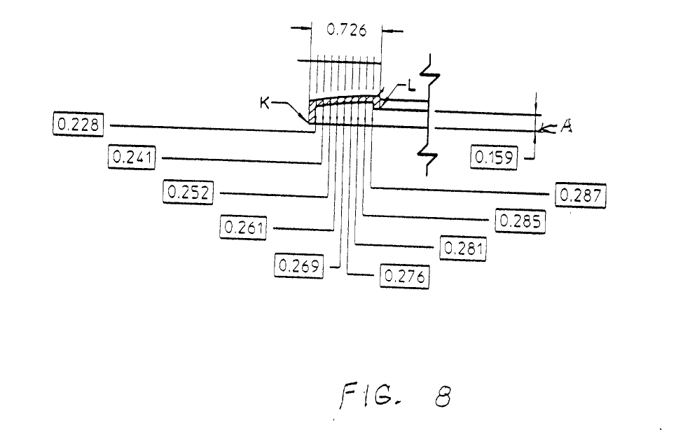

Continuing with FIG. 6, a captive member 130 composed of phosphor bronze, spring brass, spring steel or the like is securely attached to the lugs 122 which form the ends of the ground strap of switch 110. Captive member 130 contains a first opening 132 which is aligned with opening 126 in the lug and a second opening 134 which is aligned with opening 128 in the underlying lug. Opening 132 can be oval or rectangular in shape to allow a mounting screw to be positioned off center. A centrally located projection 136 bent at a slight downward angle toward the body of the switch is provided to engage and hold loosely captive the threaded body of the mounting screw. Engagement of projection 136 with the mounting screw provides a good electrical connection between the ground strap of the switch, the screw and the box to insure that the switch is connected to ground. The screw which passes through openings 132 and 126 of the switch and opening 117 of the alignment plate 114, threads into opening 23 in the box to hold the switch and alignment plate to the box. The openings 132 and 126 are sized to allow the screw to be moved laterally to compensate for slight misalignments that may occur. Opening 134 in captive member 130 is substantially circular and supports three inwardly projecting members bent upward at a slight angle away from the switch body. The ends of the three projecting members form an opening slightly smaller than the diameter of alignment pins 118 on alignment plate 114 and are designed to flex slightly as the alignment pin is inserted into opening 134 from the rear. The ends of the projecting members frictionally engage and hold captive the alignment pins to prevent the easy removal of the alignment pins from the captive member. Located at the end of captive member 130 are two tabs 140. The end of each tab has a double bend similar to a zero to 360 degree sine curve and are provided to engage indents on the inside ends of the cover plate to hold it in place (See FIGS. 9, 10, 11 and 12 and the descriptions which relate thereto).

During assembly the electrical cables in the box are stripped of insulation and are attached to terminals on the side or back of the switch. The alignment plate is then attached to the switch from the back. Initially, after the wires are attached to the switch, the alignment plate is held vertically in front of the switch and parallel to the switch. The top of the switch is now tilted downward from its vertical position, until it is horizontal and, while in its horizontal position, the end of the switch that was initially up is passed through opening 116 of the alignment plate which is in its vertical position. After the switch is passed completely through the opening of the alignment plate, the switch is tilted back to its initial vertical position. At this time the alignment plate is positioned around the electrical wires and is located behind the switch. The alignment plate and the switch are now moved toward each other until the front face of the alignment plate contacts the back face of the lugs on the ends of the ground strap. As the alignment plate approaches the lugs, alignment pins 118 of the alignment plate enter openings 128 in the lugs and openings 134 in captive members 130. As the alignment pins enter the openings 134, they force the upwardly bent projections to spread apart to allow the alignment pins to fully enter openings 134. The ends of the upwardly bent projections engage and hold captive the alignment pins 118. The switch, which is now attached to the alignment plate and is connected to the electrical wires, is inserted into the box. As the switch is being inserted into the box, screws 108 located in openings 132 on the captive member and clearance opening 117 in alignment plate are aligned with and threaded into openings 106 to hold both the alignment plate and switch to the box. The head of the screw which passes through opening 126 of the lug on the end of the mounting strap of the switch and opening 132 in the captive member is larger than either opening and, therefore, holds switch 110 and alignment plate 114 captive to the box.

The cover plate is now placed over the installed switch. It is here noted that the rocker paddle of the switch is not located within a frame. Thus, the rocker paddle must be accurately positioned to insure that it is free to move without contacting an adjacently positioned wiring device or cover plate. Each captive member 130 supports at least two projecting latching pawls 140. See FIGS. 4 and 6. Each latching pawl has a double curve similar to a three hundred sixty degree sine curve. After the switch is attached to the alignment plate, the two latching pawls 140 of a captive member are located on either side of a tab 120 on the alignment plate. Tab 120 functions as a tool pivot point to allow the cover plate 168 to be removed from around the switch. A slot in the lower edge of the cover plate 168 provides access for the insertion of a small flat tool such as a screw driver to facilitate removal of the cover plate from the switch.

Cover plate 168 is proportioned to fit over the alignment plate 114 as well as the box within which switch 110 is located. The cover plate is located around the switch and held in position by pawls 140 which engage saw tooth shaped teeth on the cover plate.

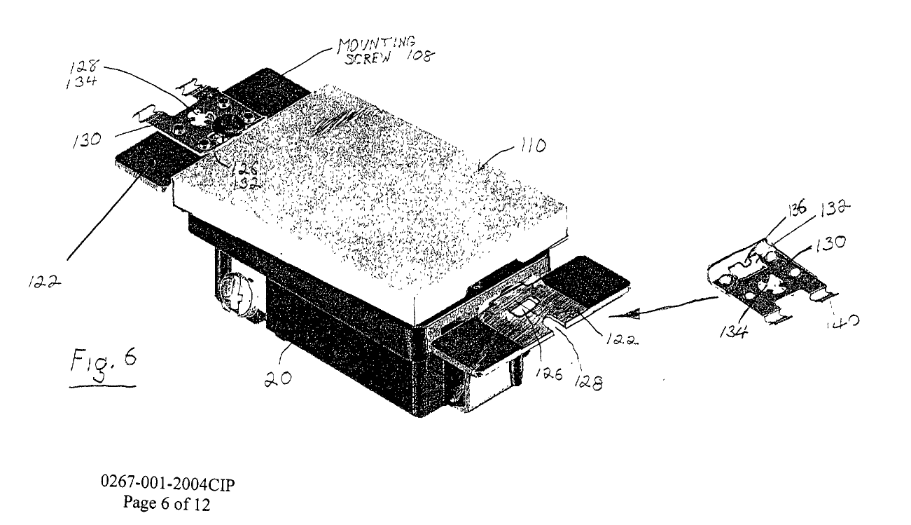

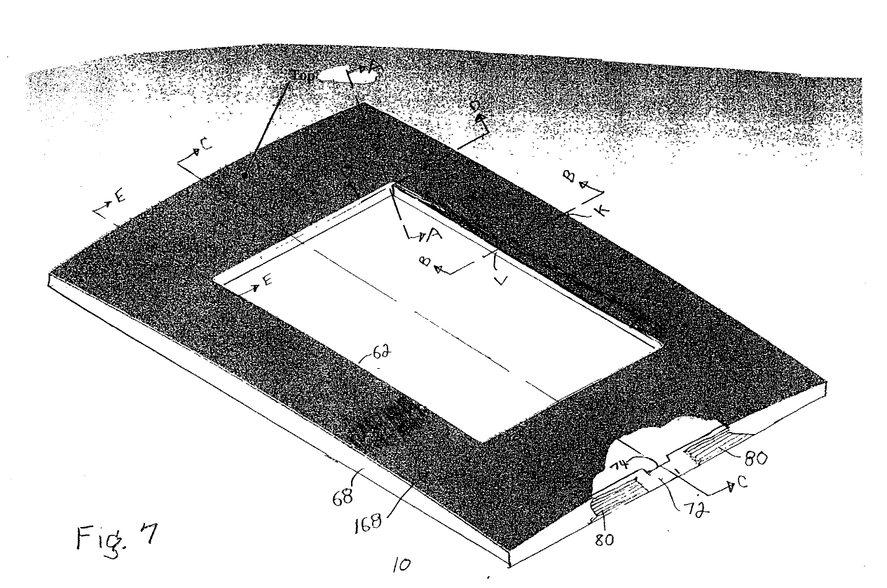

Referring to FIGS. 7-12, for a single wiring device, the width of the face of the switch is approximately 60% of the width of the wall plate along the horizontal axis and approximately 53% of the length of the wall plate along the vertical axis. For a single switch, the wall plate is substantially 4.92 inches in length by 3.28 inches in width and has a rectangular opening for receiving a switch that is substantially 2.82 inches in length by 1.83 inches in width. The width of the wall plate varies depending upon how many boxes are ganged together and the number of wiring devices that are to be located in side-by-side relationship in the ganged box. The front surface of the wall plate here disclosed has a complex contoured shape where the edge of the wall plate at the rectangular opening for the wiring device is further from the wall than the outer edge of the cover plate. More specifically, referring to FIG. 8, there is illustrated a view along the line B-B of FIG. 7 of a portion of the front surface, along the horizontal centerline, between point K, the outer right edge, and point L, the inner edge of the opening for the switch. As illustrated in FIG. 8, the surface lies between two profile boundaries 0.002 inches apart, perpendicular to datum plane A, equally disposed about the true profile and positioned with respect to a datum plane. The basic dimensions and the profile tolerance establish a tolerance zone to control the shape and size of the surface. The surface is 0.726 inches in length. Within that length, a contour is defined by the dimensions of equidistant points which are 0.0726 inches apart. Each dimension indicates that point's distance to define datum plane A, the back (flat) surface of the cover plate, which begins at point K. Moving from left to right, the dimensions increase from 0.228 to 0.287 inches. This progression indicates a contour of increasing height, positive first differential, when the points are connected by individual splines. The points are not connected by a single arc and the rate at which the contour height increases is not constant. The rate of height increase of the individual splines decreases from left to right, and the second differential of the contour is negative. That is, the difference between the first point's distance dimension and the second is larger than the difference between the second and the third, etc. Thus, the surface has a contour of positive first differential and negative second differential, comprised of a combination of splines drawn between points of varying distance from a datum plane. This description substantially describes most of the wall plate's contours for sections along lines A-A, D-D, and E-E of FIG. 7. Section along line C-C, which runs along the vertical centerline of the wall plate defines a surface having a positive first differential and zero second differential, comprised of a combination of splines drawn between points of varying distance from a datum plane. This contour has zero second differential because the rate of height increase of the individual splines is constant; the difference between any two sequential point dimensions is at a uniform spacing of 0.0037 inches.

When the wiring device is a switch, the front surface follows the same contours, surfaces and shape as the wall plate. In those instances where the wiring device is a receptacle, the contour along the width of the front of the receptacle face is flat and the contour along the length of the receptacle has a constant radius of substantially 30.724 inches. The shape of the front of the receptacle face is different from that of the switch primarily to allow for the proper seating of an inserted plug. The wall plate has no exposed mounting screws or other visible metal hardware. When the wall plate is attached to the switch, the only visible parts are the wall plate 16 and the switch 18.

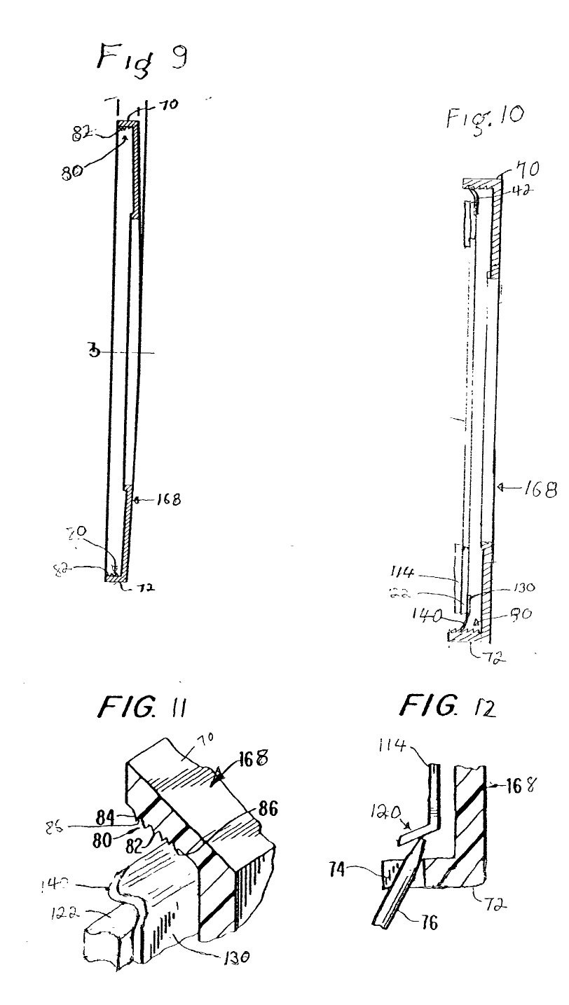

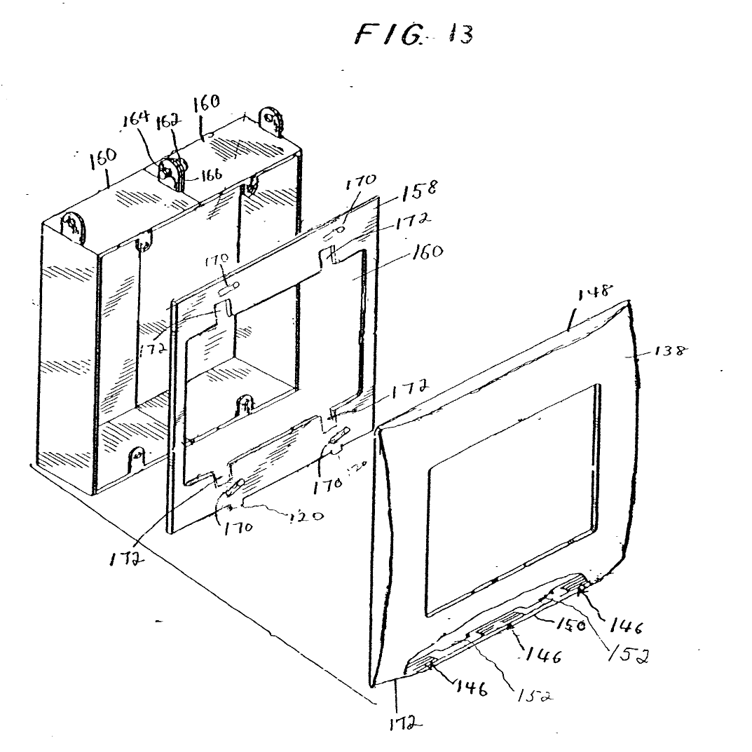

Referring to FIGS. 9-12, placed in the bottom end wall 72 of cover plate 168 is a slot 74 which provides access to the tab 120 as is seen in FIG. 12. A small, flat tool blade such as a screw driver blade 76 is moved through slot 74 in end wall 72 to contact both the outer surface of tab 120 and the back wall of slot 74. By moving the blade 76 in a counterclockwise direction using the back wall of slot 74 as a fulcrum, the force applied to tab 120 will separate cover plate 168 from the switch. To attach cover plate 168 to the switch, the pawls 140 of captive member 130 are made to engage saw-tooth shaped racks 80 located on the inner surfaces of the end walls 70 and 72 of cover plate 168. There are two racks on end wall 70 and two racks on end wall 72. Each rack 80 contains a number of saw-tooth shaped teeth 82 each having an inclined front face 84 and a vertical back face 86. As seen in FIG. 11, as latching pawl 140 engages the inclined front face 84 of a tooth, the pawl deflects in a counterclockwise direction and moves past the tip of the first tooth 82. Once pawl 140 is past the tip of tooth 82, it can return to its initial position and take a position between the vertical back face 86 of first tooth 82 and the inclined front face 84 of a second tooth 82. This operation can be repeated as many times as needed to position the bottom edges of cover plate 168 as close to the wall as possible. Since each of the racks 80 and pawls 140 are independently operated, it is possible to locate the cover plate 168 to closely follow the mounting wall contour, even when the wall is not flat. This ability to follow the wall contour is even more appreciated where the cover plate 168 is large, such as with a wall plate that is required to cover four ganged boxes.

Once the latching pawl 140 returns to its original position, it becomes difficult to dislodge the cover plate 168 from the pawl 140. However, since tool 76 can apply a great deal of force to tab 120, it is possible to separate the pawl 140 from engagement with the teeth and thus the switch from the cover plate.

Referring to FIG. 13, there is illustrated a cover plate for two wiring devices positioned side by side. It is to be noted that there is no partition or dividing member is located in the cover plate opening to separate the two wiring devices. The two wiring devices can be placed in a double ganged box 160 made up of two single ganged boxes and joined by fasteners 162 extending through the threaded apertures 164 of two joining ears 166. Additional ganged boxes can be added to increase the overall ganged box arrangement as required. Alignment plate 158 has a single opening 160, four clearance openings 172 and four alignment pins 170 for receiving two wiring devices such as two switches, a diplex receptacle and a switch or two receptacles.

Looking at the cover plate 138, there can be three racks 146 on the interior of the top and bottom end walls for receiving four pawls where the center rack is sized to receive one pawl from each wiring device. Also, there can be two tabs 120, one for each switch, which will be accessible via slots 152 in end wall 172 of cover plate 138. Because of the independent operation of the pawls 140 with their respective racks 146, the cover plate 138 will be able to compensate somewhat for lack of flatness of the wall in which the wiring devices are installed.

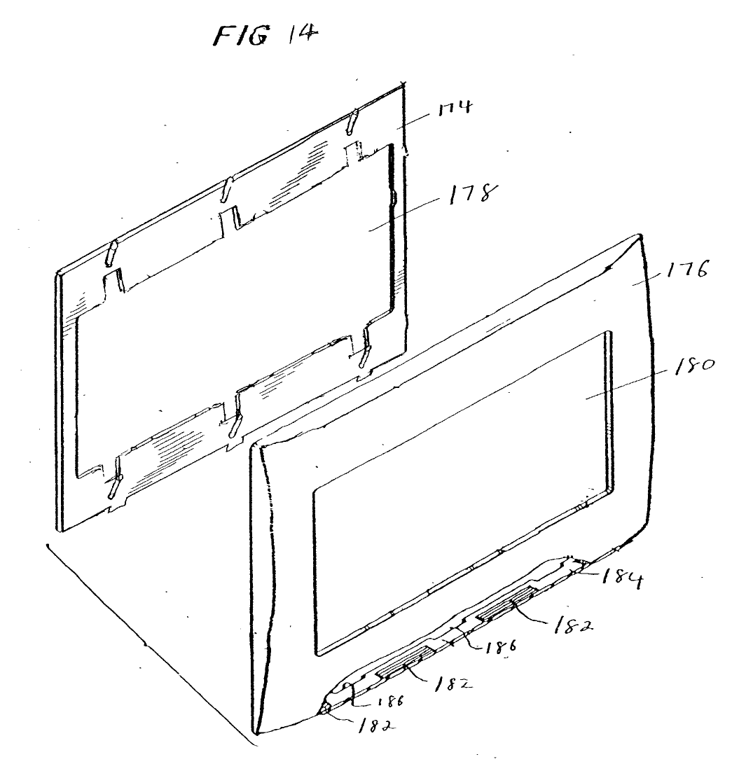

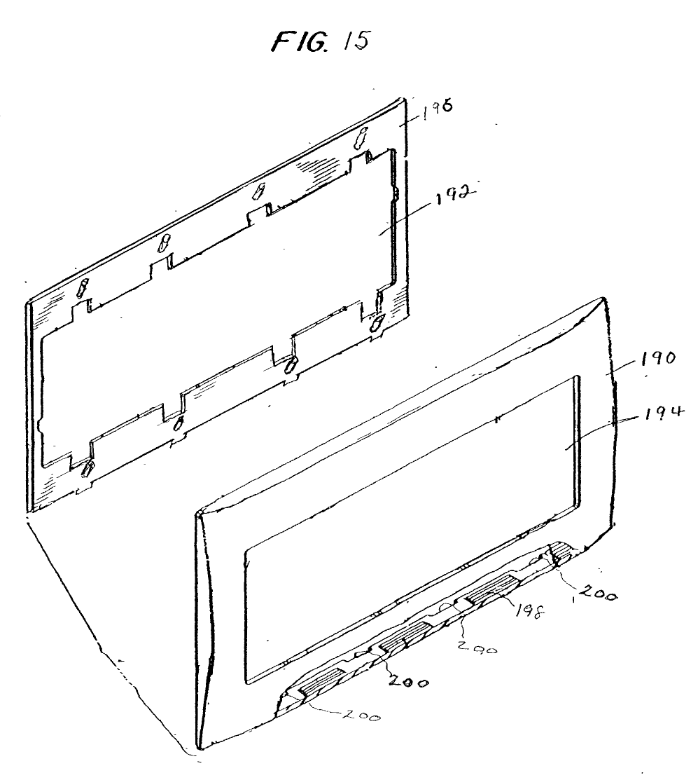

Referring to FIG. 14 there is shown an alignment plate 174 and a cover plate 176 for three wiring devices mounted in three boxes ganged together. Cover plate 176 has a single opening 180 for receiving three wiring devices positioned side by side and can have four sets of racks 182 where the two end racks each receive a single pawl and the two center racks each receive two pawls. The alignment plate 174 has a single opening 178, three sets of clearance openings and three sets of alignment pins for receiving three wiring device.

FIG. 15 shows an alignment plate 196 and cover plate 190 for four ganged boxes and the four wiring devices they can mount. According to the observations made above, for an even number of wiring devices to be installed within an attachment plate and cover plate, there will be a single cut-out or aperture 192 in alignment plate 196 and a single cut-out or aperture 194 in cover plate 190. Cover plate 190 will supports five sets of racks 198 on the upper and lower end walls which cooperate with the pawls of the wiring devices. In addition, the lower end wall of the cover plate will have four cutouts 200 for receiving the four tabs from the four wiring devices.

While there have been shown and described and pointed out the fundamental novel features of the invention as applied to the preferred embodiments, it will be understood that various omissions and substitutions and changes of the form and details of the devices illustrated and in their operation may be made by those skilled in the art without departing from the spirit of the invention.

What is claimed is:

1. A cover plate for a wall box mountable wiring device comprising:
a rectangular frame having a vertical axis along its length and a horizontal axis along its width and a centrally located rectangular opening for receiving a single electric wiring device, the frame having a thickness that is progressively thinner from the edge of the rectangular opening to the outer edge of the cover plate along its vertical and horizontal axis.

2. The cover plate of claim 1 wherein the thickness of the frame changes at a rate that is not constant.

3. The cover plate of claim 2 wherein a section along the vertical axis of the cover plate has a surface with a contour of positive first differential comprised of a combination of splines drawn between points of varying distance from a datum plane.

4. The cover plate of claim 3 wherein the section along the vertical axis of the cover plate has a surface with a contour of zero second differential comprised of splines drawn between points of varying distance from a datum plane when the rate of height increase of the individual splines is constant.

5. The cover plate of claim 2 wherein a section along the horizontal axis from the outer edge of the cover plate to the edge of the centrally located rectangular opening has a surface with contour of a positive first differential and negative second differential, comprised of a combination of splines drawn between points of varying distance from the datum plane.

6. The cover plate of claim 2 wherein a section along the vertical axis of the cover plate has a surface with a contour of positive first differential, comprised of splines drawn between points of varying distance from a datum plane, and a section along the horizontal axis from the outer edge of the cover plate to the edge of the centrally located rectangular opening has a surface with contour of a positive first differential, comprised of a combination of splines drawn between points of varying distance from the datum plane.

7. The cover plate of claim 6 wherein the section along the horizontal axis from the outer edge of the cover plate to the edge of the centrally located rectangular opening has a surface with contour of negative second differential, comprised of a combination of splines drawn between points of varying distance from the datum plane.

8. The cover plate of claim 7 wherein the section along the vertical axis of the cover plate has a surface with a contour of zero second differential comprised of splines drawn between points of varying distance from a datum plane when the rate of height increase of the individual splines is constant.

9. The apparatus of claim 3 wherein the wiring device is a receptacle.

10. The apparatus of claim 4 wherein the wiring device is a receptacle.

11. The apparatus of claim 5 wherein the wiring device is a receptacle.

12. The apparatus of claim 6 wherein the wiring device is a receptacle.

13. The apparatus of claim 7 wherein the wiring device is a receptacle.

14. The apparatus of claim 8 wherein the wiring device is a receptacle.

15. The apparatus of claim 3 wherein the wiring device is a switch.

16. The apparatus of claim 4 wherein the wiring device is a switch.

17. The apparatus of claim 5 wherein the wiring device is a switch.

18. The apparatus of claim 6 wherein the wiring device is a switch.

19. The apparatus of claim 7 wherein the wiring device is a switch.

20. The apparatus of claim 8 wherein the wiring device is a switch.

21. The apparatus of claim 8 wherein the wiring device is a switch the face of which has a contour that is a continuation of the contour of the cover plate.
